(19) United States
(12) Patent Application Publication
(10) Pub. No.: US 2012/0131462 A1
(43) Pub. Date: May 24, 2012

(54) HANDHELD DEVICE AND USER INTERFACE CREATING METHOD

(75) Inventor: YI-CHING CHEN, Tu-Cheng (TW)

(73) Assignee: HON HAI PRECISION INDUSTRY CO., LTD., Tu-Cheng (TW)

(21) Appl. No.: 13/092,156

(22) Filed: Apr. 22, 2011

(30) Foreign Application Priority Data
Nov. 24, 2010 (CN) 201010557595.2

(51) Int. Cl. G06F 3/16

(52) U.S. Cl. 715/727

(57) ABSTRACT

A handheld device stores mapping relationships between a plurality of user sound types and a plurality of user situations. The handheld device detects a user sound signal from surrounds of the handheld device, and analyzes the user sound signal to obtain a corresponding user sound type. The handheld device determines a corresponding user situation according to the corresponding user sound type and the mapping relationships between the plurality of user sound types and the plurality of user situations, and creates a user interface corresponding to the determined user situation.

### BACKGROUND

1. Technical Field

The present disclosure relates to communication devices, and more particularly to a handheld device and a user interface creating method.

2. Description of Related Art

A handheld device often provides a user interface by which a user interacts with the handheld device. The user interface may take any form, such as a visual display or a sound.

However, the user interface of the handheld device needs to be pre-defined by the user, and cannot automatically change with different situations of the user (“user situations”).

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of one embodiment of a handheld device comprising functional modules;

FIG. 2 shows one example of a sound wave graph of a groaning sound stored in the handheld device in accordance with the present disclosure;

FIG. 3 shows one example of a sound wave graph of a coughing sound stored in the handheld device in accordance with the present disclosure;

FIG. 4 shows one example of a sound wave graph of a wheezing sound stored in the handheld device in accordance with the present disclosure

FIG. 5 shows one example of a sound wave graph of a person speaking stored in the handheld device in accordance with the present disclosure;

FIG. 6 shows one example of a sound wave graph of a filtered groaning sound stored in the handheld device in accordance with the present disclosure;

FIG. 7 shows one example of a sound wave graph of a filtered coughing sound stored in the handheld device in accordance with the present disclosure;

FIG. 8 is a flowchart of one embodiment of a user interface creating method in accordance with the present disclosure;

FIG. 9 is a detailed flowchart of one embodiment of the user interface creating method of FIG. 8; and

FIG. 10 is a detailed flowchart of another embodiment of the user interface creating method of FIG. 8.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

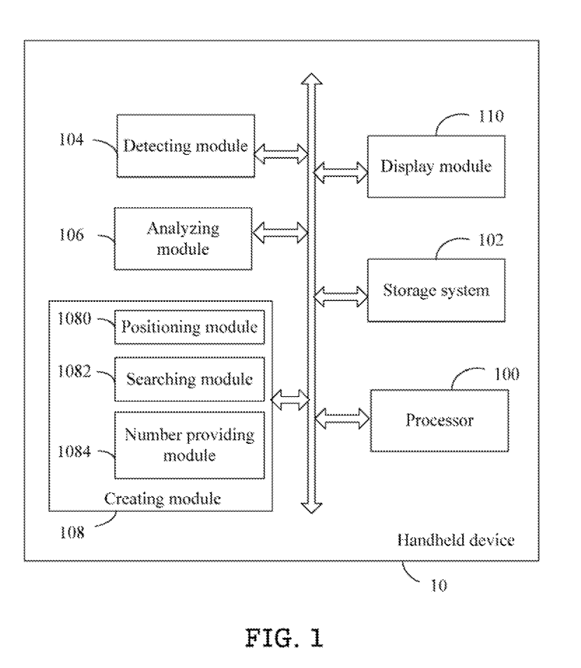

FIG. 1 is a schematic diagram of one embodiment of a handheld device 10 comprising functional modules. In one embodiment, the handheld device 10 may be a PDA, a mobile phone, a smart phone, or a mobile Internet device, for example.

In one embodiment, the handheld device 10 includes at least one processor 100, a storage system 102, a detecting module 104, an analyzing module 106, and a creating module 108. The modules 102-108 may comprise computerized code in the form of one or more programs that are stored in the storage system 102. The computerized code includes instructions that are executed by the at least one processor 100 to provide functions for the modules 102-108. In one example, the storage system 102 may be a hard disk drive, flash memory, or other computerized memory device.

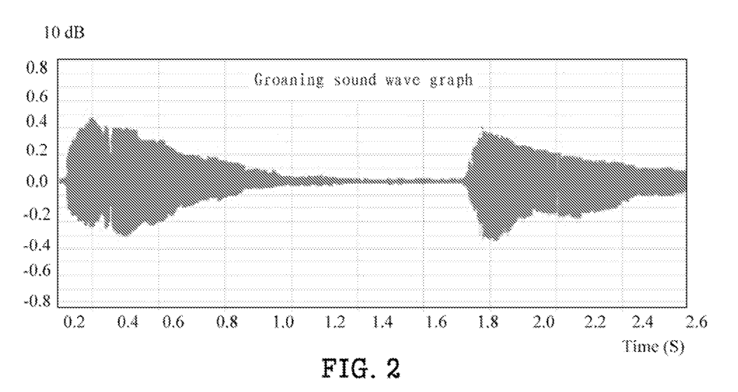

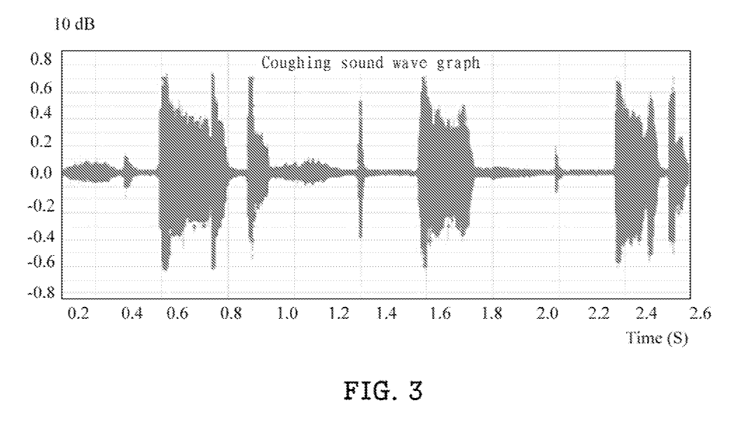

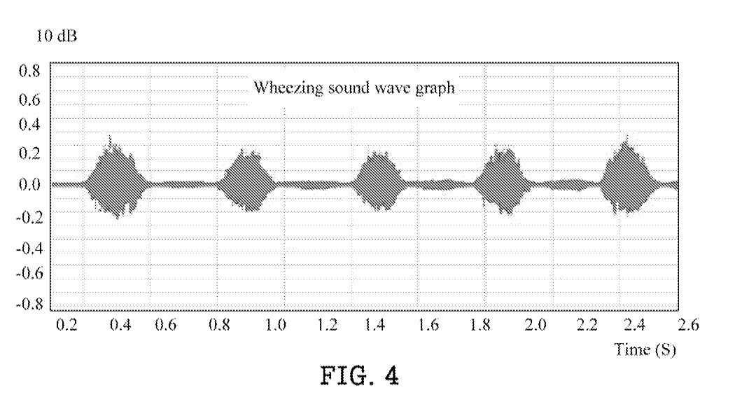

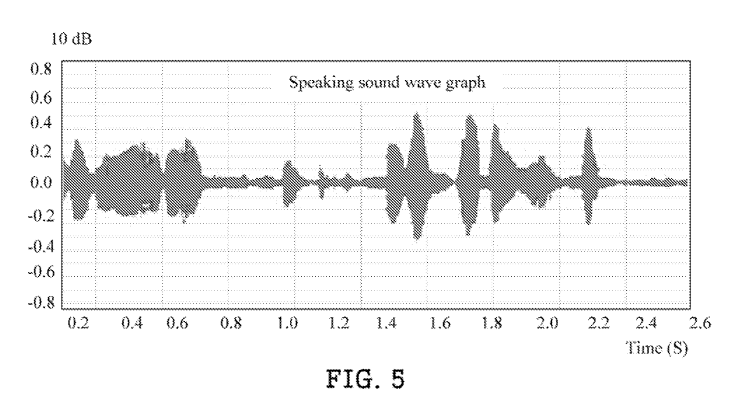

The storage system 102 is operable to store a plurality of sound wave graphs corresponding to a plurality of sound types of a user (“user sound types”), and mapping relationships between the plurality of user sound types and a plurality of situations of the user (“user situations”). In one embodiment, the plurality of sound wave graphs corresponding to the plurality of user sound types may include a sound wave graph of a groaning sound (“groaning sound wave graph”) shown in FIG. 2, a sound wave graph of a coughing sound (“coughing sound wave graph”) shown in FIG. 3, a sound wave graph of a wheezing sound (“wheezing sound wave graph”) shown in FIG. 4, and a sound wave graph of a person speaking (“speaking sound wave graph”) shown in FIG. 5, for example.

In one embodiment, the mapping relationships between the plurality of user sound types and the plurality of user situations may include: a groaning sound type if the user situation is a person suffering; a coughing sound type if the user situation is a person sick; a wheezing sound type if the user situation is a person doing sports; a speaking sound type if the user situation is normal; a crying sound type if the user situation is a person sad; a sound type of a stomach growling if the user situation is a person hungry; a laughing sound type if the user situation is a person happy; a yawning sound type if the user situation is a person sleepy; a snoring sound type if the user situation is a person sleeping. It should be understood that the above mapping relationships have been presented using examples and not using limitation, which can be defined according to different requirements.

The detecting module 104 is operable to detect a user sound signal from surrounds of the handheld device 10. The analyzing module 106 is operable to analyze the user sound signal to obtain a corresponding user sound type and determine a corresponding user situation according to the corresponding user sound type and the mapping relationships between the plurality of user sound types and the plurality of user situations. The creating module 108 is operable to create a user interface corresponding to the determined user situation.

In one embodiment, the handheld device 10 may further include a display module 110 operable to display the user interface created by the creating module 108.

In one embodiment, the detecting module 104 may detect the user sound signal via a microphone, and then generate a corresponding sound wave graph according to the user sound signal. The analyzing module 106 directly compares the generated sound wave graph with the plurality of sound wave graphs stored in the storage system 102 to obtain a corresponding user sound type. For example, when a user of the handheld device 10 is coughing, the detecting module 104 detects a coughing user sound signal and generates a coughing sound wave graph according to the coughing user sound signal. The analyzing module 106 compares the coughing sound wave graph with the plurality of sound wave graphs stored in the storage system 102 to obtain a coughing user sound type. Then, the analyzing module 106 determines that the user situation is the user sick according to the coughing user sound type.

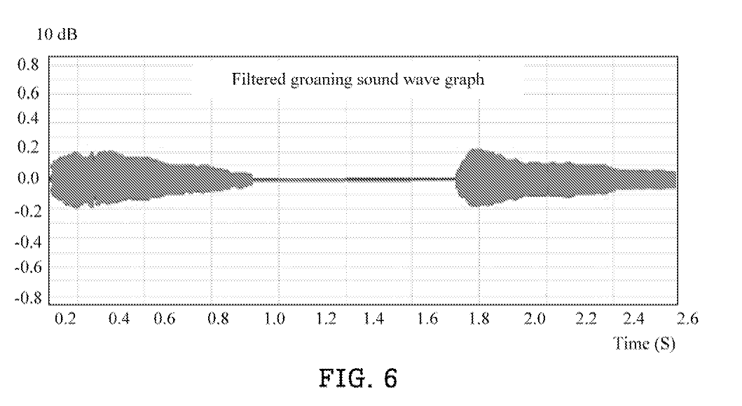

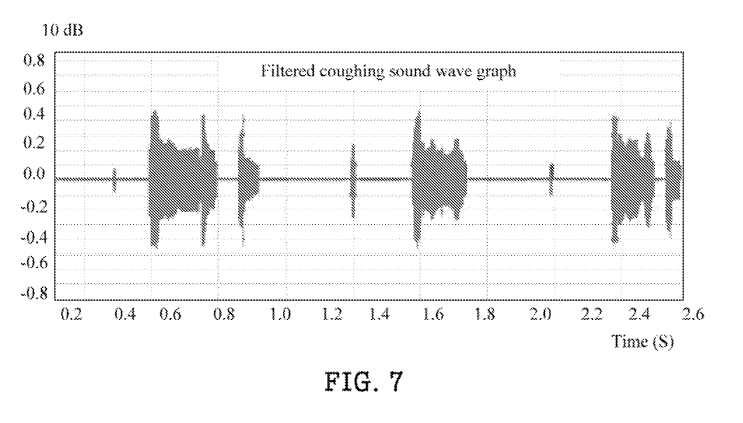

In another embodiment, the generated sound wave graph may include noise. In order to enhance comparison accurateness and speed, the analyzing module 106 may filter noise from the generated sound wave graph, and then compare the filtered sound wave graph with the plurality of sound wave graphs stored in the storage system 102 to obtain a corresponding user sound type. For example, examples of a filtered groaning sound wave graph and a filtered coughing sound wave graph are respectively shown in FIG. 6 and FIG. 7.

In one embodiment, the creating module 108 may include a positioning module 1080 operable to determine a current position of the handheld device 10. The positioning module 1080 may determine a current position of the handheld device 10 via a global positioning system (GPS), or according to signals from a base station.

The creating module 108 may further include a searching module 1082 operable to search for information related to the corresponding user situation near the current position from the Internet.

The creating module 108 may further comprise a number providing module 1084 operable to provide at least one predefined telephone number to the user of the handheld device 10 according to the corresponding user situation.

In a first example, if the detecting module 104 detects a crying user sound signal, then the analyzing module 106 determines that the user situation is sad. Accordingly, the creating module 108 provides his/her close friends' telephone numbers to the user via the number providing module 1084, so that the user can call his/her friends.

In a second example, if the detecting module 104 detects a growling user sound signal of a stomach of the user, then the analyzing module 106 determines that the user situation is hungry. In such a case, the creating module 108 provides the user a map with food information via the positioning module 1080 and the searching module 1082, so that the user can follow the food information to find some food.

In a third example, if the detecting module 104 detects a laughing user sound signal, then the analyzing module 106 determines that the user situation is happy. Accordingly, the creating module 108 shows some animations on a screen of the display module 110, which can join happy emotion with the user.

In a fourth example, if the detecting module 104 detects a yawning user sound signal, then the analyzing module 106 determines that user situation is sleepy. Accordingly, the creating module 108 may find hotel location nearby via the positioning module 1080 and the searching module 1082, and shows the hotel location nearby via the display module 110. The creating module 108 may also play good-night music to remind the user to go to sleep.

In a fifth example, if the detecting module 104 detects a snoring user sound signal, then the analyzing module 106 determines that user situation is sleeping. Accordingly, the creating module 108 may automatically make the user interface turn to a sleep mode.

In a sixth example, if the detecting module 104 detects a coughing user sound signal, then the analyzing module 106 determines that user situation is sick. Accordingly, the creating module 108 may find drugstore and hospital location via the positioning module 1080 and the searching module 1082, and show the drugstore and hospital location to the user via the display module 110.

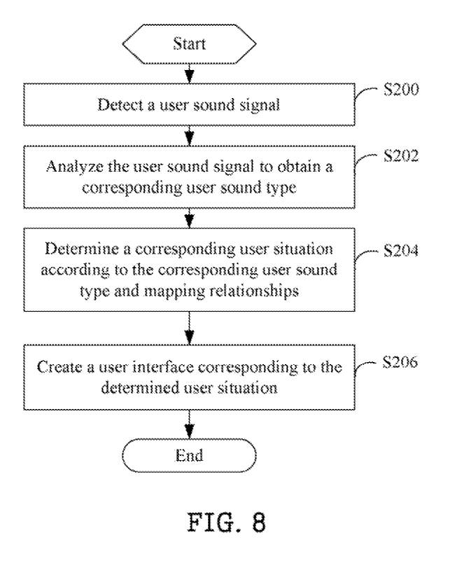

FIG. 8 is a flowchart of one embodiment of a user interface creating method in accordance with the present disclosure. In one embodiment, the user interface creating method may be embodied in the handheld device 10, and is executed by the functional modules such as those of FIG. 1. Depending on the embodiment, additional blocks may be added, others deleted, and the ordering of the blocks may be changed while remaining well within the scope of the disclosure.

In block S200, the detecting module 104 detects a user sound signal from surrounds of the handheld device 10.

In block S202, the analyzing module 106 analyzes the user sound signal to obtain a corresponding user sound type.

In block S204, the analyzing module 106 determines a corresponding user situation according to the corresponding user sound type and the mapping relationships between the plurality of user sound types and the plurality of user situations stored in the storage system 102.

In block S206, the creating module 108 creates a user interface corresponding to the determined user situation.

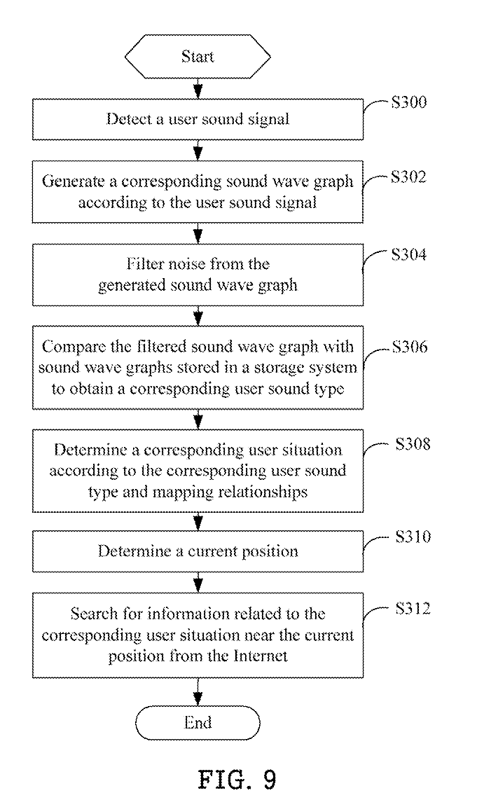

FIG. 9 is a detailed flowchart of one embodiment of the user interface creating method of FIG. 8.

In block S300, the detecting module 104 detects a user sound signal via a microphone.

In block S302, the detecting module 104 generates a corresponding sound wave graph according to the user sound signal.

In block S304, the analyzing module 106 filters noise from the generated sound wave graph.

In block S306, the analyzing module 106 compares the filtered sound wave graph with the plurality of sound wave graphs stored in the storage system 102 to obtain a corresponding user sound type.

In other embodiments, block S304 may be omitted, and the analyzing module 106 directly compares the generated sound wave graph with the plurality of sound wave graphs stored in the storage system 102 to obtain a corresponding user sound type as shown in block S306.

In block S308, the analyzing module 106 determines a corresponding user situation according to the corresponding user sound type and the mapping relationships between the plurality of user sound types and the plurality of user situations. In one example, if the corresponding user sound type is coughing, the corresponding user situation is sick. If the corresponding user sound type is yawning, the corresponding user situation is sleepy.

In block S310, the creating module 108 determines a current position via the positioning module 1080.

In block S312, the creating module 108 searches for information related to the corresponding user situation near the current position from the Internet via the searching module 1082. For example, if the corresponding user situation is sick, the creating module 108 searches for drugstore and hospital location nearby from the Internet via the searching module 1082. If the corresponding user situation is sleepy, the creating module 108 searches for hotel location nearby from the Internet via the searching module 1082.

In other embodiments, the creating module 108 may search for the information related to the corresponding user situation all over the world from the Internet.

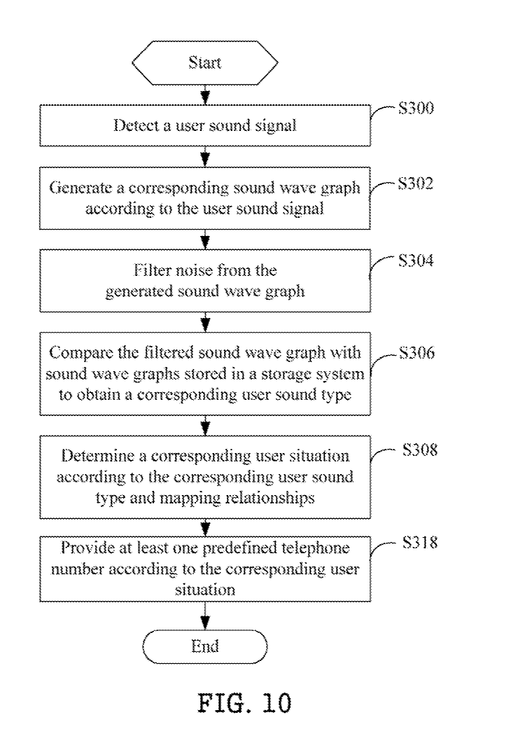

FIG. 10 is a detailed flowchart of another embodiment of the user interface creating method of FIG. 8.

Blocks S300-S308 of FIG. 10 are the same as those of FIG. 9, so descriptions are omitted.

In block S318, the creating module 108 provides at least one predefined telephone number to the user according to the corresponding user situation. For example, if the corresponding user situation is crying, the creating module 108 provides his/her close friends' telephone numbers to the user via the number providing module 1084, so that the user can call out to talk with his/her close friends.

In conclusion, the handheld device 10 can analyze the user sound signal to obtain a user sound type, determine a user situation according to the user sound type, and then create a user interface corresponding to the user situation. Thus, the user interface can change with the user situation.

While various embodiments of the present disclosure have been described above, it should be understood that they have been presented using example and not using limitation. Thus the breadth and scope of the present disclosure should not be limited by the above-described embodiments, but should be defined in accordance with the following claims and their equivalents.

What is claimed is:

1. A handheld device, comprising:
a storage system operable to store mapping relationships between a plurality of user sound types and a plurality of user situations;
at least one processor;
one or more programs that are stored in the storage system and are executed by the at least one processor, the one or more programs comprising:
a detecting module operable to detect a user sound signal from surrounds of the handheld device;
an analyzing module operable to analyze the user sound signal to obtain a corresponding user sound type and determine a corresponding user situation according to the corresponding user sound type and the mapping relationships between the plurality of user sound types and the plurality of user situations; and
a creating module operable to create a user interface corresponding to the determined user situation.

2. The handheld device of claim 1, further comprising a display module operable to display the user interface created by the creating module.

3. The handheld device of claim 1, wherein the storage system is further operable to store a plurality of sound wave graphs corresponding to the plurality of user sound types, and the detecting module is further operable to generate a corresponding sound wave graph according to the user sound signal.

4. The handheld device of claim 3, wherein the analyzing module compares the generated sound wave graph with the plurality of sound wave graphs stored in the storage system to obtain a corresponding user sound type.

5. The handheld device of claim 3, wherein the analyzing module filters noise from the generated sound wave graph, and compares the filtered sound wave graph with the plurality of sound wave graphs stored in the storage system to obtain a corresponding user sound type.

6. The handheld device of claim 1, wherein the creating module comprises a positioning module operable to determine a current position of the handheld device.

7. The handheld device of claim 6, wherein the creating module further comprises a searching module operable to search for information related to the corresponding user situation near the current position from the Internet.

8. The handheld device of claim 7, wherein the creating module further comprises a number providing module operable to provide at least one predefined telephone number to the user of the handheld device according to the corresponding user situation.

9. A user interface creating method of a handheld device comprising:
storing mapping relationships between a plurality of user sound types and a plurality of user situations in a storage system;
detecting a user sound signal from surrounds of the handheld device;
analyzing the user sound signal to obtain a corresponding user sound type;
determining a corresponding user situation according to the corresponding user sound type and the mapping relationships between the plurality of user sound types and the plurality of user situations; and
creating a user interface corresponding to the determined user situation.

10. The user interface creating method of claim 9, further comprising: displaying the created user interface.

11. The user interface creating method of claim 9, further comprising: storing a plurality of sound wave graphs corresponding to the plurality of user sound types in the storage system.

12. The user interface creating method of claim 11, wherein the detecting step comprises: generating a corresponding sound wave graph according to the user sound signal.

13. The user interface creating method of claim 12, wherein the analyzing step comprises: comparing the generated sound wave graph with the plurality of sound wave graphs stored in the storage system to obtain a corresponding user sound type.

14. The user interface creating method of claim 12, wherein the analyzing module comprises: filtering noise from the generated sound wave graph; and comparing the filtered sound wave graph with the plurality of sound wave graphs stored in the storage system to obtain a corresponding user sound type.

15. The user interface creating method of claim 9, wherein the creating step comprises: determining a current position of the handheld device; and searching for information related to the corresponding user situation near the current position from the Internet.

16. The user interface creating method of claim 9, wherein the creating step comprises: providing at least one predefined telephone number to the user of the handheld device according to the corresponding user situation.
